(19) United States
(12) Patent Application Publication
(10) Pub. No.: US 2025/0145430 A1
(43) Pub. Date: May 8, 2025

(54) INFLATABLE FIBRE REINFORCED BAG

(71) Applicant: Taniq NC B.V., Rotterdam (NL)

(72) Inventors: Sören BLOMAARD, Schiedam (NL); Coen TEN HERKEL, Rotterdam (NL)

(21) Appl. No.: 18/867,951

(22) PCT Filed: May 18, 2023
(86) PCT No.: PCT/NL2023/000008

§ 371 Date: Nov. 21, 2024

(30) Foreign Application Priority Data
May 25, 2022 (NL) 1044340

(51) Int. Cl. B66F 3/35

(52) U.S. Cl. CPC B66F 3/35

(57) ABSTRACT

This invention is directed to an inflatable fibre reinforced bag having a flat and generally round shape in uninflated condition, comprising at least one interior elastomer layer, a fibre reinforcement structure and an outer elastomer layer, wherein a reinforcement structure consisting of continuously wound reinforcement fibers running from pole to pole substantially closes said poles.

Inflatable fibre reinforced bags can be implemented as so-called air lifting bags that are primarily used in low insertion height situations with heavy weight needing to be lifted such as buildings, bridges, vehicle or structural rescue, load shifting, heavy truck or aircraft recovery and machinery moving.

Lifting bags traditionally have a rectangular, preferably square geometry. They are manufactured by manually folding several layers of fabric reinforced sheets of unvulcanized rubber into a square shape, which is then vulcanized by compressing the unvulcanized (‘green’) product in a press between two moulding plates. No mandrel is used during the manufacturing process. When these square shaped lifting bags are inflated their flat square shape transforms into a ‘pillow’ shape.

To improve some inefficiencies found in such traditional square shape lifting bags, such as, for example, stress concentrations in the corner areas, a round lifting bag was developed as described in EP 0 626 338 A1. The round lifting bag of EP 0 626 838 A1 is designed as an isotensoid structure, which means that all reinforcement cords are equally tensioned when the lifting bag is inflated in its free (unloaded) condition. The isotensoid structure described in EP 0 622 338 A1 is obtained by geodetically winding the reinforcement cords over a predetermined shape, defined by

$$V = \frac{2 * π * {Y}_{0}^{3}}{3} * \sqrt{\frac{{( {q}^{2} + q + 1 )}^{5}}{{( {q}^{2} + q )}^{3} * ( 2 q + 1 )}} * {\int }_{0}^{\frac{π}{2}} \sqrt{1 - \frac{q - 1}{2 q + 1} * {sin}^{2} θ} * d θ \\ wherein q is defined as \\ q = \frac{{Y}_{u}^{2}}{{Y}_{i}^{2}}$$

Y₀ is the diameter of the pole opening, Yu is the smallest radius of the optimal part of the pressure vessel, and Yi is the largest radius of the optimal part of the pressure vessel, resulting in a three-dimensional mandrel having the shape of a flattened cylinder with continuous, curved edges, a squeezed sphere like the shape of a Gouda-cheese. For the purpose of manufacturing the inflatable bag the material layers, such as elastomer and fibre reinforcement layers, are arranged against an outer side of the mandrel, wherein a shape of the mandrel defines a shape of the body cavity of the body in question. After or during a forming process, in which for instance a certain degree of curing of the layer of material takes place, the mandrel is removed from the body.

It is noted that patent publication EP 2 960 033 A2 describes a design and use of such three-dimensional mandrel, assembled from a set of mutually cohesive body parts, the body parts being mutually releasable and the body parts being removable via the opening.

An advantage of the lifting bag from EP 0 626 338 A1 compared to the traditional square shape bags is that the isotensoid reinforcement structure provides a better force distribution along the reinforcement structure, resulting in a more efficient material usage and a better force-stroke (lifting) curve.

In the manufacturing process described in EP 0 626 338 A1 the reinforcement cords, which are applied through automated fibre winding, are wound on a three-dimensional mandrel with the shape as defined by the equation mentioned above, while the manufacturing of the traditionally square shaped bags, which are manufactured by manually folding of fabric reinforced rubber sheets, does not require a mandrel. Further, in the process described in EP 0 626 338 A1 also the elastomer layer(s) are applied on the three-dimensional mandrel rendering the process more complex. The opening for removing the three-dimensional mandrel from the body, after or during the forming process, is created in a process of winding the reinforcement fibres up to a certain distance from the pole, thereby also creating a polar opening in the reinforcement structure of the hollow body. As a result, the round shape lifting bags produced by the method of

EP 0 626 338 A1 need additional closing elements, e.g. metal flanges, to close these polar openings in the hollow fabric reinforced elastomer body. However, the use of such closing flanges increases the thickness and weight of the product which is undesired from a product performance point of view.

Patent publication WO 2018/233803 A1 describes a production method for manufacturing of a round shaped lifting bag comprising an inner elastomer layer, a fabric reinforcement layer and an outer elastomer outer layer. According to WO 2018/233803 A1 the reinforcement layer comprises a single- or multilayer, prefabricated two-dimensional fiber-reinforcing layer in the form of a tube or a tubular structure which is pulled over the entire arrangement of the core like a ‘stocking’. According to the description the reinforcement ‘stocking’ could be pulled over the entire core, potentially also covering the pole, such that no polar opening exists. Whereas the method described in WO 2018/233803 A1 does not require the winding of continuous fiber in a certain winding geometry including the necessary apparatus design, as would be required for EP 0 622 338 A1, and the polar areas could potentially by covered as well, the resulting reinforcement structure does not have the efficiency of the reinforcement structure as obtained by the method of EP 0 622 338 A1 obtained through reinforcement cords following geodesic paths running from pole to pole.

It is an object of the present invention to provide an improved inflatable fibre reinforced bag, having the advantages of the efficient reinforcement structure as described in EP 0 622 338 A1, and also having the advantages of having substantially closed polar openings such that no additional closing elements are required.

It is an object of the present invention to provide an improved inflatable fibre reinforced bag. In particular, it is an object of the present invention to provide a bag that has a lower insertion height. Thereto, according to an aspect of the invention, the fibre reinforcement structure being formed by continuous winding of fibres between opposite poles of the bag is substantially closing both poles. Since there are no substantial polar openings in the fibre reinforced rubber structure, no metal closing flanges are required anymore. In the absence of metal closing flanges, the insertion height of the bag is considerably lower and the overall weight is lower, thereby improving the bag performance. In case the mandrel remains in the bag, then its material and construction cannot have a hindering effect during operational use of the bag.

Further advantageous embodiments according to the invention are described in the following claims.

The invention will now be further elucidated on the basis of a number of exemplary embodiments and an accompanying drawing. In the drawing:

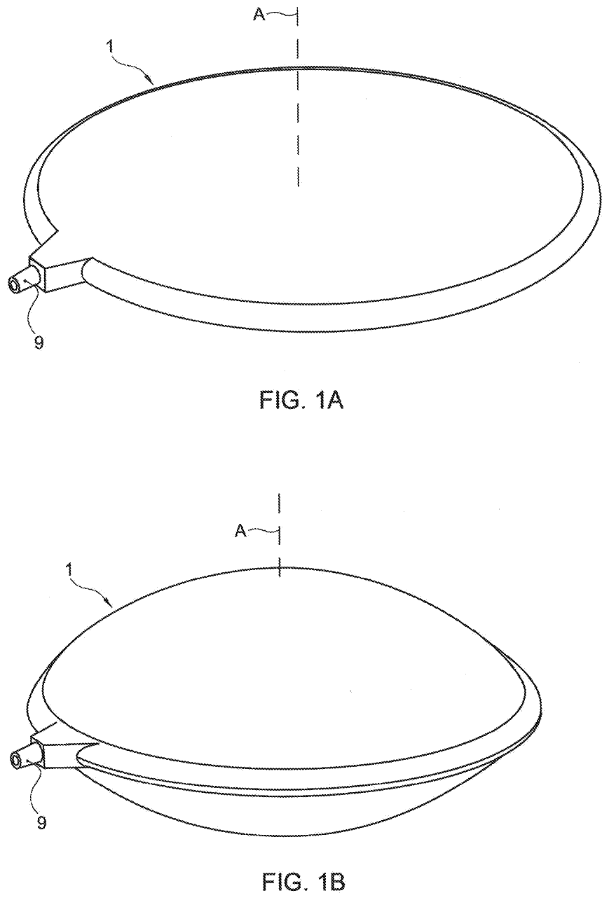

FIG. 1A shows a schematic perspective view of an exemplary embodiment of a fibre reinforced inflatable bag according to the invention in a deflated state;

FIG. 1B shows the bag of FIG. 1A in an inflated state;

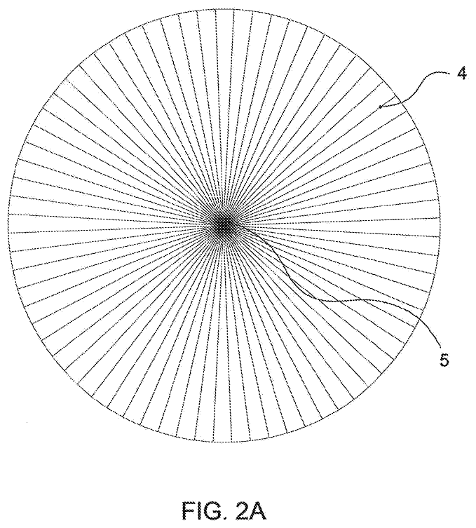

FIG. 2A shows a schematic top view of a fibre reinforcement structure according to the invention showing fibres running from pole to pole substantially closing said poles;

FIG. 2B shows a schematic top view of another reinforcement structure according to the invention showing fibres running from pole to pole leaving a polar opening;

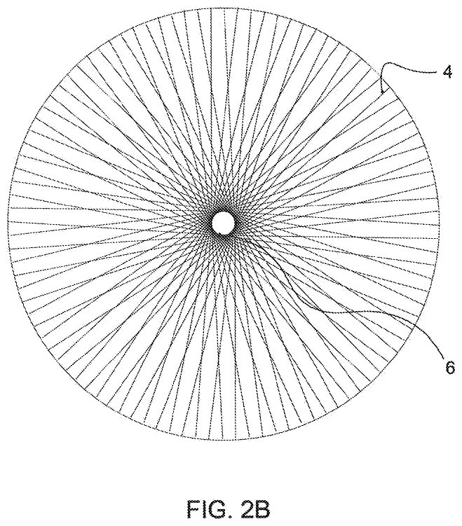

FIG. 3A shows a schematic cross-sectional view of a fibre reinforced inflatable bag shown in FIG. 1A;

FIG. 3B shows a schematic cross-sectional view of a fibre reinforced inflatable bag having two fibre layers;

FIG. 3C shows a schematic cross-sectional view of a fibre reinforced inflatable bag shown in FIG. 1A comprising an element of prefabricated fibre reinforcement material in a peripheral region, extending towards the poles;

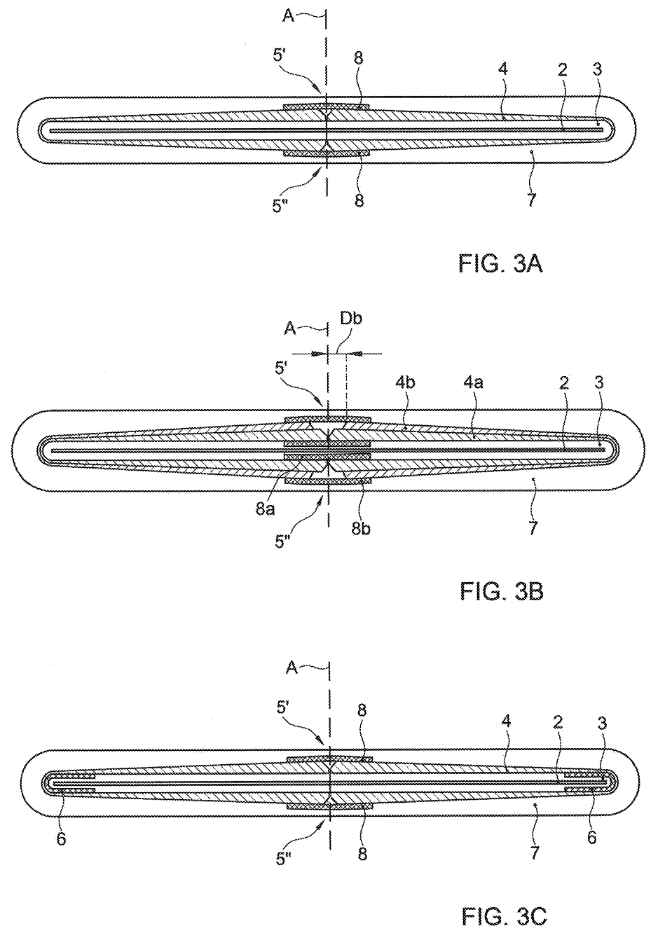

FIG. 4A is a graph which illustrates the thickness build-up of a reinforcement structure of a single reinforcement layer having substantially closed poles;

FIG. 4B is a graph which illustrates the thickness build-up of a reinforcement structure having three reinforcement layers, each layer having a different distance to a pole of the inflatable bag;

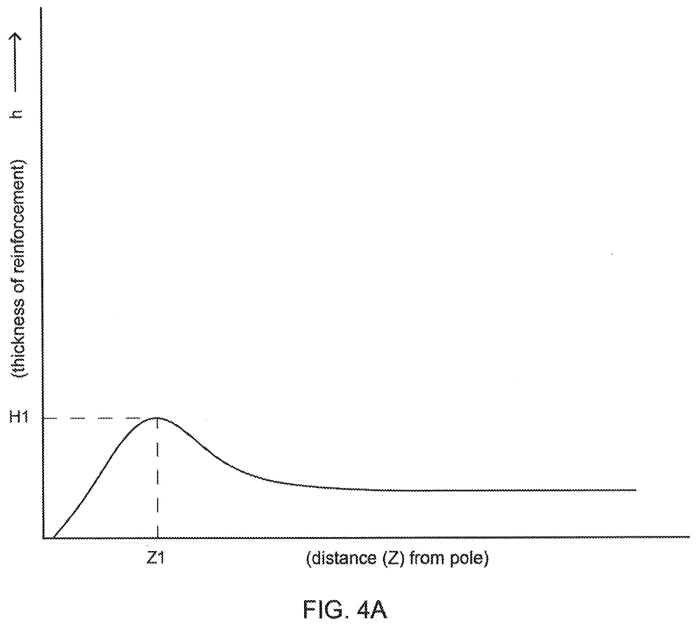

FIGS. 5A-5F show schematic views of different configurations of the contour of the fibre reinforcement structure and the outside contour of the bag.

FIG. 5A shows a schematic view of a fibre reinforcement structure having a rotation symmetric geometry and an outer contour of the bag having a rotation symmetric geometry.

FIG. 5B shows a schematic view of a fibre reinforcement structure having a rotation symmetric geometry and an outer contour of the bag having a non-rotation symmetric geometry having radially extending parts, providing handles for manipulation of the bag.

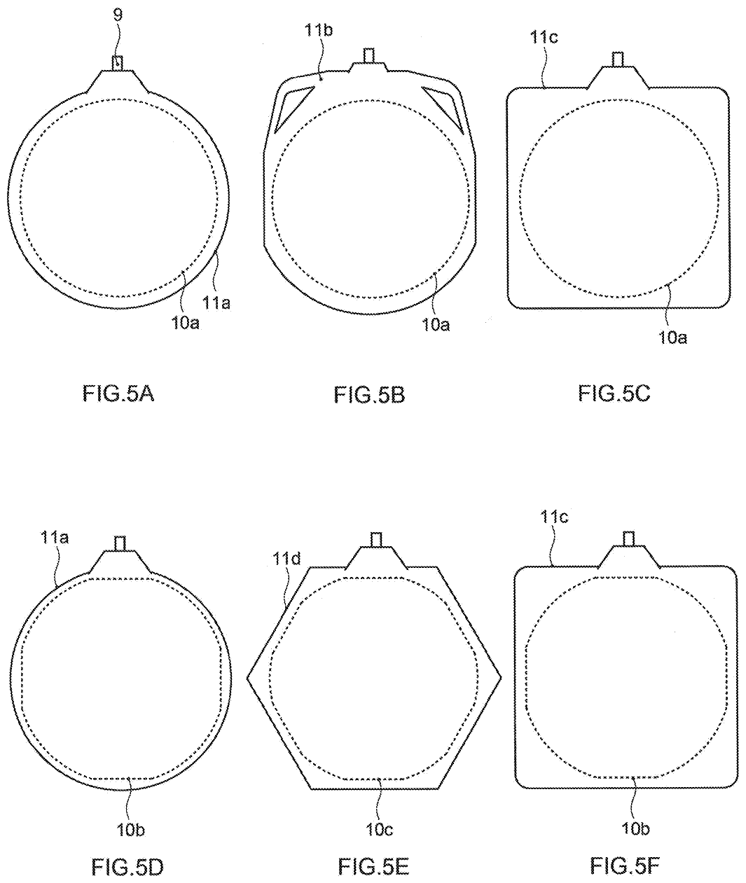

FIG. 50 shows a schematic view of a fibre reinforcement structure having a rotation symmetric geometry and an outer contour of the bag having a rectangular geometry.

FIG. 5D shows a schematic view of a fibre reinforcement structure having a geometry which comprises a combination of circular sections and straight sections and an outer contour of the bag having a rotation symmetric geometry.

FIG. 5E shows a schematic view of a fibre reinforcement structure having a non-rotation symmetric geometry having the shape of a hexagon with rounded corners and an outer contour of the product having a non-rotation symmetric geometry having the shape of a hexagon.

FIG. 5F shows a schematic view of a fibre reinforcement structure having a geometry which comprises a combination of circular sections and straight sections and an outer contour of the product having a rectangular geometry.

It is noted that the figures show merely preferred embodiments according to the invention. In the figures, the same reference numbers refer to equal or corresponding parts.

FIG. 1A shows a schematic perspective view of an exemplary embodiment of a fibre reinforced inflatable bag 1 according to the invention. The bag 1 is provided with an input port 9 having a valve for inflating and deflating, respectively, the bag 1. In FIG. 1A, the bag is in a deflated state. The bag 1 has a generally rotationally symmetric geometry with respect to a rotation axis of symmetry A and can be used as a so-called lift-bag for lifting heavy objects such as collapsed buildings, e.g. in emergency situations. Generally, a lift-bag can be brought from a deflated state to an inflated state by pressurizing the bag 1. Similarly, by de-pressurizing the bag 1 can be brought from an inflated state to a deflated state. Generally, the bag can be stored and transported in its deflated state while the bag may be generating a lifting force when positioning and pressurizing the bag.

FIG. 1B shows a schematic perspective view of the bag 1 in an inflated state. Again, the bag 1 has a generally rotationally symmetric geometry with respect to the rotation axis of symmetry A.

FIG. 2A shows a schematic top view of a fibre reinforcement structure according to the invention. The fibre reinforcement structure comprises fibres 4 running from pole 5 to pole 5 substantially closing said poles 5. The poles 5 are located opposite to each other at the rotation axis of symmetry A. In FIG. 2B a schematic top view of another fibre reinforcement structure according to the invention is shown. Here, the fibre reinforcement structure comprises fibres 4 running from pole to pole leaving a polar opening 6.

Preferably, the fibre reinforcement structure of the bag is wound with a single or a multiple number of fibres, between opposite poles of the bag. The single or multiple number of fibres may be wound geodetically. Advantageously, multiple fibres, can be wound consecutively or simultaneously, e.g. using a manually controlled or automated filament winding equipment. The reinforcement fibres can for example be bundles of flat yarns or can have a cord construction. The reinforcement fibres can be rubberized and/or embedded in a rubber strip for preparing the process of forming a reinforcement layer structure. It is noted that, instead of continuously winding the fibres, another winding approach can be adopted, e.g. by winding the fibre reinforcement structure in an intermittent manner using separate fibres or strips of fibres embedded in rubber having a relatively short length, resulting in multiple beginnings and endings.

By eliminating the metal closing elements, which are no longer needed since the polar openings are substantially closed by the fibre reinforcement structure, an inflatable structure having a small height, in its deflated state, can be realized

FIG. 3A shows a schematic cross-sectional view of a fibre reinforced inflatable bag 1 with the fibre reinforcement structure substantially closing the poles shown in FIG. 2A. The bag 1 in FIG. 3A includes a sandwich structure wherein a first elastomer layer 3, also called elastomer liner, is covered by the single fibre layer 4. Then, a second elastomer layer 7 is applied on top of the single fibre layer 4 so that the fibre 4 is embedded in elastomer material forming a fibre reinforced layer structure 3, 4, 7. The fibre 4 is wound close to the poles 5′, 5″ substantially closing the poles 5′, 5″. Optionally, an additional reinforcement element 8 is applied underneath or on top of the fibre layer 4 for additional reinforcement of the poles 5′, 5″ and polar region. The additional reinforcement element 8 may be implemented as a textile reinforcement and/or may include a thin plate, e.g. 1-2 mm thick metal plate. The fibre reinforced structure 3, 4, 7 surrounds a compartment 2 that can be inflated and deflated, respectively, via the input port 9 shown in FIG. 1. In FIG. 3A the bag is shown in a deflated state wherein no or substantially no air or other gas is present in the compartment 2. The compartment 2 is surrounded by the elastomer liner 3 that is gas impermeable.

FIG. 3B shows a schematic cross-sectional view of a fibre reinforced inflatable bag 1. The fibre reinforcement structure comprises two layers of reinforcement fibres, the first interior layer 4a having a substantially closed pole and the second layer 4b leaving a polar opening. Here, a multiple number of fibre layers 4a, 4b are present, such that a bottom layer 4a is wound closer to a pole 5 than a top layer 4b covering the bottom layer 4a. Again, the fibre layers 4a, 4b are sandwiched between the elastomer liner 3 and the elastomer cover 7 for forming a fibre reinforced layer structure 3, 4, 7. Optionally, an elastomer layer could be added in between the fibre layers 4a and 4b. The fibre bottom layer 4a is wound close to the poles 5′, 5″ substantially closing the poles 5′, 5″. Further, the fibre top layer 4b is wound up to an offset distance Db to a bag pole 5. At the offset distance Db, the fibre top layer 4b surrounds a polar opening 6, at each of the poles 5′, 5″. The reinforcement cords can be spread over different polar openings in an integral manner, wherein the reinforcement cords are wound at the different polar openings in an alternating sequence. Alternatively, the reinforcement cords can be spread over different polar openings in a gradual manner, whereby the reinforcement cords are wound at increasingly larger polar opening per subsequent loop or subsequent number of loops. The reinforcement layer may have different polar openings on both sides of the bag. Optionally, one or more additional reinforcement elements 8 are applied underneath or on top of the fibre layers 4a, 4b in the polar region. By applying multiple fibre layers 4, polar openings may stepwise increase. As an example, two, three, four or even more fibre layers could be applied. Said polar openings can be additionally reinforced using additional reinforcement elements described above, however, such that the overall thickness of the reinforced layer structure is relatively small.

FIG. 3C shows a schematic cross-sectional view of a fibre reinforced inflatable bag 1 with the fibre reinforcement structure substantially closing the poles shown in FIG. 3A. Optionally, an additional reinforcement element 6 may be applied in the peripheral region underneath or on top of the fibre layer 4 for additional reinforcement of the peripheral region. The additional reinforcement element 6 may be implemented as a (prefabricated) textile reinforcement. Generally, the bags shown in FIGS. 3A, 3B and 3C include an inflatable reinforced elastomer body formed by the fibre reinforced layer structure 3, 4, 7.

FIG. 4A is a graph which illustrates the thickness build-up of a reinforcement structure of a single reinforcement layer 4 having substantially closed poles 5. Here, the thickness h is depicted as a function of a distance z from the rotation axis of symmetry A. Starting with zero distance z, the graph has a maximum thickness H₁ at a distance z1. With increasing distance z, the thickness of the layer decreases until it reaches the minimum thickness of that layer. As a result, the maximum thickness build-up of the reinforcement structure has a value H₁.

FIG. 4B is a graph which illustrates the thickness build-up of a reinforcement structure having three reinforcement layers, the fibre layers 4a, b, c surrounding a corresponding pole 6, wherein a first, bottom layer 4a forms a substantially closed pole, while a second layer 4b and a third layer 4c leave a polar opening 6 having a corresponding diameter. Preferably, the size of the respective polar openings 6, in other words the distance from the pole 5 to the fibres in a respective layer 4b, 4c, increases stepwise with each subsequent reinforcement layer. In the shown graph, a first local maximum thickness HH1 is reached due to the first bottom fibre layer 4a at a first distance z₁, a second local maximum thickness HH2 is reached at a first distance z₂ due to a second fibre layer 4b covering the first fibre layer 4a, and a third local maximum thickness HH3 is reached at a first distance z₃ due to a third fibre layer 4c covering the second fibre layer 4b. The third local maximum thickness HH3 is also a global maximum thickness that is smaller than the maximum thickness H1 resulting from the single reinforcement layer 4 shown in FIG. 4A, thus illustrating that a total build-up thickness can be reduced by dividing the reinforcement structure into multiple fibre layers spreading radially outwardly.

By spreading out the fibre build-up thickness in the polar area a more flattened surface in the polar region may be created when the bag is in its inflated state. Adding an additional reinforcement element 8 of a stiff material (e.g. thin metal plate) on top or underneath the fibre reinforcement layer 4 in the polar region will further enhance a more flattened surface in the polar region when the bag is in its inflated state. Having a more flattened surface in the polar region may be beneficial for providing a more stable lifting surface.

It is noted that, in principle, the fibre reinforcement structure has a generally rotationally symmetric geometry with respect to a rotation axis of symmetry A, but may also have another shape contour. Furthermore, the outer contour of the bag may have a rotation symmetric geometry, but may also have another shape contour. As an example, the outer contour of the bag may be rectangular, elliptical or polygonal, or circular while having one or more radially extending parts (e.g. handles) in the peripheral region.

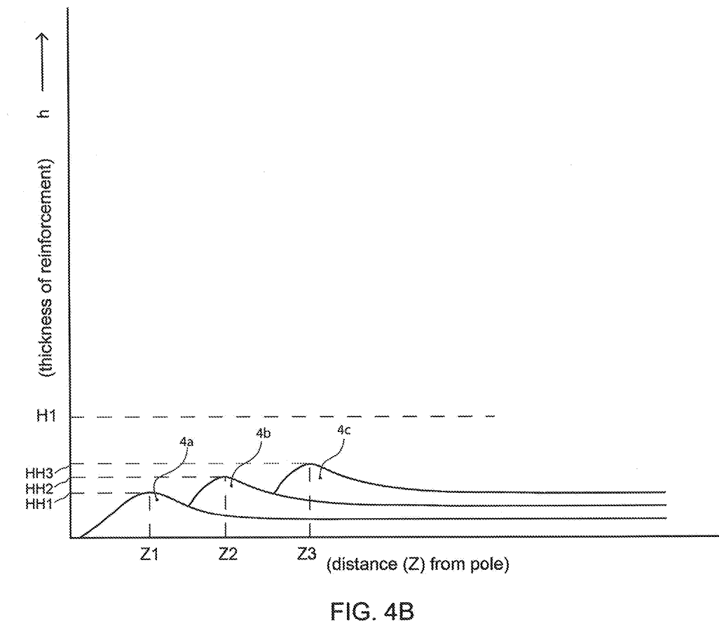

FIGS. 5A-5F show different embodiments for the geometries of the reinforcement structure and contour of the bag. It will be understood that the possibilities are not restricted by the embodiments shown in FIGS. 6A-5F, and that many variants are possible.

FIG. 5A shows a schematic view of a fibre reinforcement structure having a rotation symmetric geometry 10a and comprising an outer contour of the product having a rotation symmetric geometry 11a. At the location in the peripheral region of the bag where the valve 9 is located, additional material may be added around the valve, providing a radially extended part supporting the valve.

FIG. 5B shows a schematic view of a fibre reinforcement structure having a rotation symmetric geometry 10a and an outer contour of the product having a non-rotation symmetric geometry having radially extending parts 11b, providing handles for manipulation of the bag.

FIG. 5C shows a schematic view of a fibre reinforcement structure having a rotation symmetric geometry 10a and an outer contour of the product having a rectangular geometry 11c.

FIG. 5D shows a schematic view of a fibre reinforcement structure having a geometry which is non-rotation symmetric and comprises a contour shape consisting of circular sections and straight sections 10b, and having rotation symmetric outer contour of the bag 11a.

In another embodiment, both the contour of the reinforcement structure and the outer contour of the bag may have a non-rotation symmetric geometry.

FIG. 5E shows a schematic view of a fibre reinforcement structure having a non-rotation symmetric geometry in the form of a hexagon with rounded corners 10c and an outer contour of the bag having a non-rotation symmetric geometry in the the shape of a hexagon 11d.

FIG. 5F shows a schematic view of a fibre reinforcement structure having a geometry which is non-rotation symmetric and comprises a contour shape consisting of circular sections and straight sections 10b, and an outer contour of the product having a rectangular geometry 11c.

The invention is not restricted to the embodiments described above. It will be understood that many variants are possible.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. An inflatable, fibre reinforced bag having a flat and generally round shape in an uninflated condition, the inflatable, fibre reinforced bag comprising:
at least one interior elastomer layer;
a fibre reinforcement structure covering the at least one interior elastomer layer, the fibre reinforcement structure being formed by a continuous winding of fibres between opposite poles of the bag substantially closing each pole of the opposite poles;
an exterior elastomer layer covering the fibre reinforcement structure; and
an inflation valve unit penetrating the at least one interior elastomer layer, the fibre reinforcement structure and the exterior elastomer layer.

2. The inflatable, fibre reinforced bag according to claim 1, wherein the fibre reinforcement structure comprises a plurality of fibre reinforcement layers forming a packet of layers.

3. The inflatable, fibre reinforced bag according to claim 2, wherein a first fibre reinforcement layer, of the plurality of fibre reinforcement layers, located closer to an interior side of the bag is wound closer to a pole, of the opposite poles, than a second fibre reinforcement layer, of the plurality of fibre reinforcement layers, located more remote from the interior side of the bag.

4. The inflatable, fibre reinforced bag according to claim 3, wherein a third fibre reinforcement layer, of the plurality of fibre reinforcement layers, located closest to the interior side of the bag is wound closest to a pole, of the opposite poles, and a fourth fibre reinforcement layer, of the plurality of fibre reinforcement layers, located, more remotely from the interior side of the bag is positioned further away from the pole than the third fibre reinforcement layer.

5. The inflatable, fibre reinforced bag according to claim 2, wherein the fibre reinforcement structure comprises the plurality of fibre reinforcement layers, further comprises an intermediate elastomer layer sandwiched between subsequent fibre reinforcement layers, of the plurality of fibre reinforcement layers, of the fibre reinforcement structure.

6. The inflatable, fibre reinforced bag according to claim 1, further comprising an additional reinforcement element near at least one of the opposite poles.

7. The inflatable, fibre reinforced bag according to claim 1, further comprising an element of prefabricated fibre reinforcement material in a peripheral region, extending towards the opposite poles.

8. The inflatable, fibre reinforced bag according to claim 5, wherein at least one of said at least one interior elastomer layer, said intermediate elastomer layer, or said exterior elastomer layer has been vulcanized onto the fibre reinforcement structure.

9. The inflatable, fibre reinforced bag according to claim 1, wherein the fibre reinforcement structure has a rotation symmetric geometry, and an outer shape of the bag has a non-rotation symmetric geometry.

10. The inflatable, fibre reinforced bag according to claim 1, wherein the bag has a generally rotation symmetric shape, and wherein the bag is provided, in a peripheral region with at least one radially extending part, providing at least one additional functionality.

11. The inflatable, fibre reinforced bag according to claim 1, wherein the fibre reinforcement structure has a non-rotation symmetric shape.

12. The inflatable, fibre reinforced bag according to claim 11, wherein the non-rotation symmetric shape comprises one of a closed countour comprising circular portions and substantially straight sections interconnecting subsequent circular portions or a polygon contour.

13. The inflatable, fibre reinforced bag according to claim 10, wherein the at least one additional functionality comprises a handle configured for manipulation of the bag.
